(19) United States
(12) Patent Application Publication
(10) Pub. No.: US 2024/0119253 A1
(43) Pub. Date: Apr. 11, 2024

(54) DOMAIN-BASED LEARNING FOR AUTOENCODER MODELS

(71) Applicant: SAP SE, Walldorf (DE)

(72) Inventors: Florian Knoerzer, Karlsruhe (DE); Swen Koenig, Schwetzingen (DE); Dominic Hehn, Speyer (DE); Mustafa Aktan, Wiesloch (DE); Jocelyn Borella, Karlsruhe (DE); Naseer Muhammad, Bad Hersfeld (DE)

(21) Appl. No.: 17/957,891

(22) Filed: Sep. 30, 2022

(51) Int. Cl. G06N 3/04

(52) U.S. Cl. CPC G06N 3/04

(57) ABSTRACT

In an example embodiment, an additional classifier is introduced to an autoencoder neural network. The additional classifier performs an additional classification task during the training and testing phases of the autoencoder neural network. More precisely, the autoencoder neural network learns to classify the domain (or origin) of each specific input sample. This leads to additional contextual awareness in the autoencoder neural network, which improves the reconstruction quality during both the training and testing phases. Thus, the technical problem of decreased autoencoder neural network reconstruction quality caused by high data variance is addressed.

### TECHNICAL FIELD

This document generally relates to machine learning. More specifically, this document relates to domain-based learning for autoencoder models.

### BACKGROUND

An autoencoder is a type of artificial neural network used to learn efficient coding of data. The encoding is validated and refined by attempting to regenerate the input from the encoding. The autoencoder learns a representation (encoding) for a set of data.

### BRIEF DESCRIPTION OF DRAWINGS

The present disclosure is illustrated by way of example and not limitation in the figures of the accompanying drawings, in which like references indicate similar elements.

FIG. 1 is a block diagram illustrating a domain autoencoder neural network, in accordance with an example embodiment.

FIG. 2 is a block diagram illustrating the domain autoencoder neural network of FIG. 1 in more detail.

FIG. 3 is a flow diagram illustrating a method of generating synthetic data, in accordance with an example embodiment.

FIG. 4 is a block diagram illustrating an architecture of software, which can be installed on any one or more of the devices described above.

FIG. 5 illustrates a diagrammatic representation of a machine in the form of a computer system within which a set of instructions may be executed for causing the machine to perform any one or more of the methodologies discussed herein, according to an example embodiment.

### DETAILED DESCRIPTION

The description that follows discusses illustrative systems, methods, techniques, instruction sequences, and computing machine program products. In the following description, for purposes of explanation, numerous specific details are set forth in order to provide an understanding of various example embodiments of the present subject matter. It will be evident, however, to those skilled in the art, that various example embodiments of the present subject matter may be practiced without these specific details.

Machine learning has impacted and disrupted many industries due to hardware and algorithmic advancements and the availability of large amounts of data. This has enabled improvements in existing processes or even opened new business opportunities at unprecedented scale. In some industries, though, the extensive adoption of this technology has been delayed or even halted by the fear of breaching local and global data protection regulations like the General Data Protection Regulation (GDPR), the California Consumer Privacy Act (CCPA), or the Personal Information Protection Law (PIPL), to mention a few. As these regulations are meant to protect the privacy of data subjects and prevent abuses, the processing of any information related to a natural person is quite restricted, and non-compliance with these regulations may result in significant financial damages for an organization.

Additionally, data used to train machine learning models (called training data) can be difficult to obtain in certain circumstances. Thus, programmers are often tasked with creating data to be used to train the models, typically to augment the insufficient training data they are able to obtain from other sources.

Artificially created data offers the benefit of eliminating the need for programmers to manually create data and also addresses the privacy concerns with using certain types of existing data. A challenge, however, is encountered with respect to generating synthetic data that is accurate enough in order to mimic real-world data.

One solution is to utilize an autoencoder neural network to generate synthetic data. For example, the autoencoder neural network may be designed to take a set of input samples and generate an artificial output with the same size as the input data samples. During a training phase, the autoencoder neural network learns to reconstruct data that is as similar as possible to its input.

Using autoencoder neural networks, however, creates a technical issue that needs to be solved. Specifically, the generated synthetic data from an autoencoder neural network will have a high variance. Specifically, if input data samples are rather distinct, such as from being sourced from different domains (e.g., different customers, databases, or computer systems), the reconstruction quality of the autoencoder neural network decreases. Thus, the reconstructed data will be less accurate.

In an example embodiment, an additional classifier is introduced to an autoencoder neural network. The additional classifier performs an additional classification task during the training and testing phases of the autoencoder neural network. More precisely, the autoencoder neural network learns to classify the domain (or origin) of each specific input sample. This leads to additional contextual awareness in the autoencoder neural network, which improves the reconstruction quality during both the training and testing phases. Thus, the technical problem of decreased autoencoder neural network reconstruction quality caused by high data variance is addressed.

In an example embodiment, the classifier approach is utilized with sequential data, such as timeseries data.

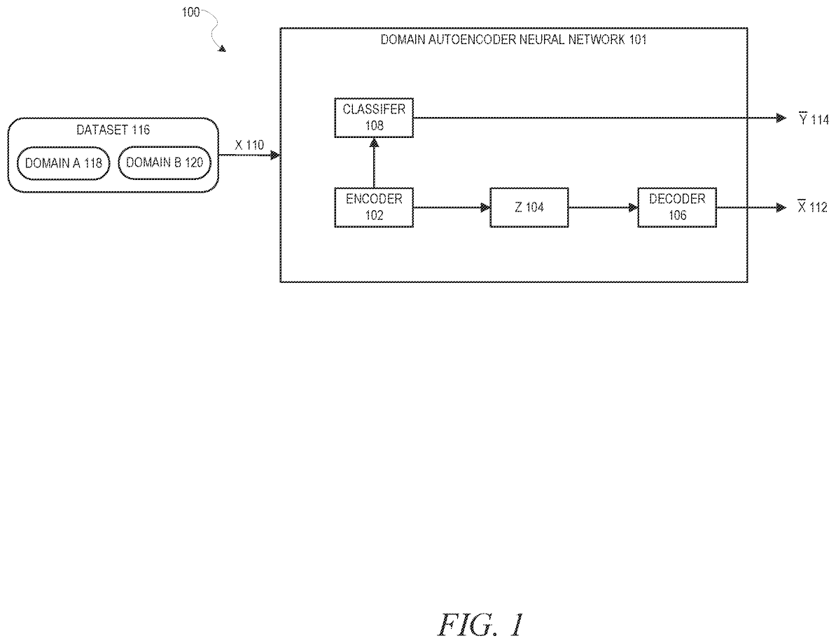

FIG. 1 is a block diagram illustrating a system 100 including domain autoencoder neural network 101, in accordance with an example embodiment. The domain autoencoder neural network 101 contains an encoder 102; latent representation, depicted as z 104; decoder 106; and classifier 108. The encoder 102 encodes an input, depicted as x 110, into latent representation z 104. During training, an informative latent representation is learned. Informative in this context means that z 104 is a compressed version of x 110, preserving the most important information of x 110. The decoder 106 reconstructs its input to x̅ 112, where x̅ 112 is as similar as possible to x 110. The decoder 106 takes latent representation z 104 as input for reconstruction.

Formally, this portion of the domain autoencoder neural network 101 is defined as the tuple n, p, m, F,G, A, B, X, Δ where:
F and G are sets
n is the input and output dimension of the autoencoder while p is the size of the latent representation
A is a class of functions from Gⁿ to F^{p} (Encoder)
B is a class of functions from P^{p} to Gⁿ (Decoder)
X is a set of m training vectors in Pⁿ
Δ is a dissimilarity or distortion function defined over Pⁿ
   The goal during training is to find functions A∈A and B∈B that minimize the distortion function such that

$$min E ( A , B ) = {min}_{A , B} {\sum }_{t = 1}^{m} E ( {x}_{t} ) = {min}_{A , B} {\sum }_{t = 1}^{m} Δ ( A ∘ B ( {x}_{t} ) , {x}_{t} ) \qquad ( 1 )$$

where E is the expectation over the distribution of x [4,5]. In terms of neural networks, the loss function can be considered as

Δ= [symbol] (x,x̅) (2)

where x̅ is the reconstruction of x.

Reconstruction loss decreases if the domain autoencoder neural network 101 is aware of the domain from which the data sample x 110 is derived. This idea is based on the assumption that data from one domain is similar and thus an autoencoder neural network 101 can reconstruct better if it knows the domain of each sample. Thus, a classifier 108 is added to the autoencoder neural network 101. The classifier 108 acts to predict the domain y̅ 114 of x 110. In other words, if a dataset 116 that includes data from domain A 118 and data from domain B 120 is used as input x 110, then classifier 108 will output, for each piece of data, a prediction of a classification of the data into either domain A 118 or domain B 120.

Possible examples of domains include, but are not limited to, distinct computer systems, customers, or values of monitoring tools. The result is that the autoencoder definition provided above is adopted as follows: Assume a training dataset D={d₁, . . . , dₙ} is composed of n distinct subsets d where n∈N and x∈D with associated domain (label) y, then the loss function from (2) can be rewritten as

Δ_{DomainAE}=α* [symbol] (x,x̅)_{AE}+β* [symbol] (y,y̅)_{c}

Autoencoder AE reconstructs x̅ based on x and classifier C predicts domain label y̅ based on x. Both loss terms are weighted by two positive numbers α and β.

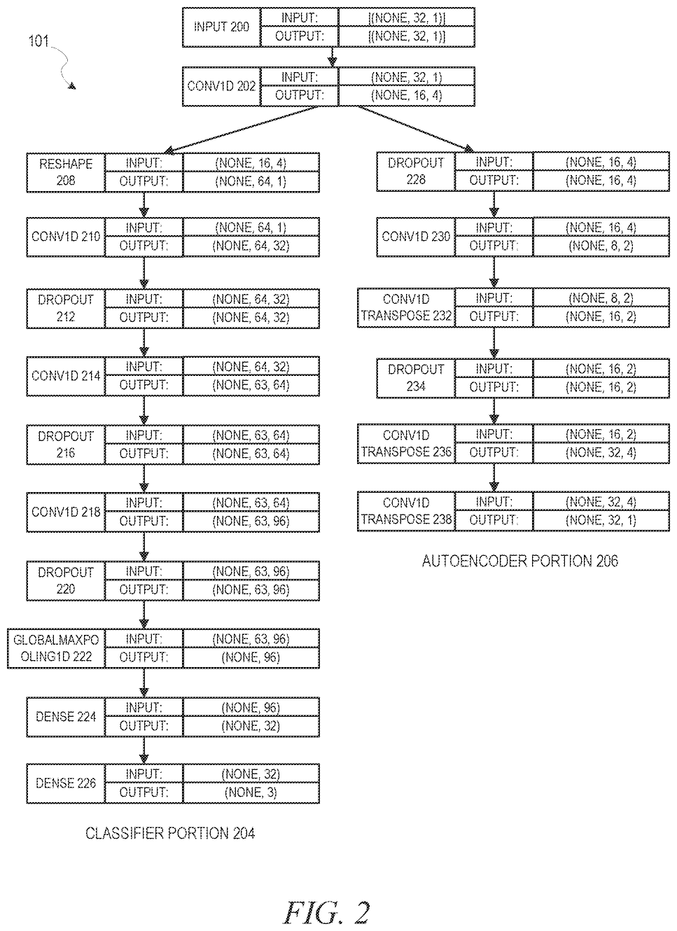

FIG. 2 is a block diagram illustrating the domain autoencoder neural network 101 of FIG. 1 in more detail. More particularly, FIG. 2 depicts the various layers of the domain autoencoder neural network 101.

An input layer 200 obtains input x 110. A shared one-dimensional convolutional layer 202 is shared between a classifier portion 204 and an autoencoder portion 206. The domain classification portion 204 includes a reshape layer 208, first one-dimensional convolutional layer 210, first dropout layer 212, second one-dimensional convolutional layer 214, second dropout layer 216, third one-dimensional convolutional layer 218, third dropout layer 220, one-dimensional global max pooling layer 222, first dense layer 224, and second dense layer 226.

The autoencoder portion 206 includes a fourth dropout layer 228, fourth one-dimensional convolutional layer 230, first one-dimensional convolutional transpose layer 232, fifth dropout layer 234, second one-dimensional convolutional transpose layer 236, and third one-dimensional convolutional transpose layer 238.

In FIG. 2, the various sizes of the inputs and outputs to each layer are also depicted in the diagram. For example, the input size of shared one-dimensional convolutional layer 202 indicates that the size of the input to shared one-dimensional convolutional layer 202 is 32×1, whereas the output size indicates that the size of the output of shared one-dimensional convolutional layer 202. The sizes of the inputs and the outputs for the various other layers are also depicted. It should be noted that the orientation, number, input sizes, and output sizes of the layers depicted in FIG. 2 are intended to be examples and one of ordinary skill in the art will recognize that embodiments are foreseen where other orientations, numbers, input sizes, and output sizes may be utilized consistent with the present disclosure. Indeed, even the layers can be adapted according to individual needs.

The various dropout layers described above are used to prevent the model from overfitting. Dropout layers operate by randomly setting the outgoing edges of units (neurons that make up layers) to 0 at each update of the training phase. Essentially, the dropout layers act as masks that nullify the contribution of some neurons towards the next layer and leave all others unmodified.

The various one-dimensional convolutional layers described above represent layers that can be used to detect features in an input vector. Each of these layers comprises a configurable number of filters, where each filter has a set size. A convolutional operation is then performed between the input vector and the filter(s), producing as output a new vector with as many channels as the number of filters.

In an example embodiment, the one-dimensional convolutional layers produce temporal convolutions. Specifically, they create a convolutional kernel that is convolved with the layer input over a single spatial or temporal dimension to produce a tensor of outputs. In some instances, a bias vector may be created and added to the outputs.

The reshape layer 208 reshapes inputs into a given shape. It can be used to change the dimensionality of its input, without changing the data. The input shape may be of arbitrary shape, although all dimensions are known.

The one-dimensional global max pooling layer 222 downsamples an input representation by taking a maximum value over a time dimension. In an example embodiment, the one-dimensional global max pooling layer 222 takes as input a string, with the ordering of the dimensions in the outputs corresponding to inputs with shape (batch, steps, features). In an example embodiment, the one-dimensional global max pooling layer 222 also takes as input a Boolean named keepdims, which indicates whether to keep the temporal dimension.

The various dense layers described above are layers of neurons in which each neuron receives input from all the neurons of the previous layer. If the input to the layer has a rank greater than 2, then this layer computes the dot products between the inputs and the kernel along the last axis of the inputs and the first axis of the kernel.

The various one-dimensional convolutional transpose layers described above are used to upsample an input feature map to a desired output feature map using some learnable parameters. These layers use a transformation going in the opposite direction of a normal convolution, i.e., from something that has the shape of the output of some convolution to something that has the shape of an input to the convolution, while maintaining a connectivity pattern that is compatible with the convolution.

Referring back to FIG. 1, the result of the use of the domain autoencoder neural network is that the generated output x̅ 112 is more reliable synthetic data than if an autoencoder without a domain classifier were utilized. In an example embodiment, the generated output x̅ 112 may then itself be used to train a machine learning model using a machine learning algorithm.

The machine learning algorithm may be selected from among many different potential supervised or unsupervised machine learning algorithms. Examples of supervised machine learning algorithms include artificial neural networks, Bayesian networks, instance-based learning, support vector machines, random forests, linear regression model, linear classifiers, quadratic classifiers, k-nearest neighbor, decision trees, and hidden Markov models. Examples of unsupervised machine learning algorithms include expectation-maximization algorithms, vector quantization, and information bottleneck methods.

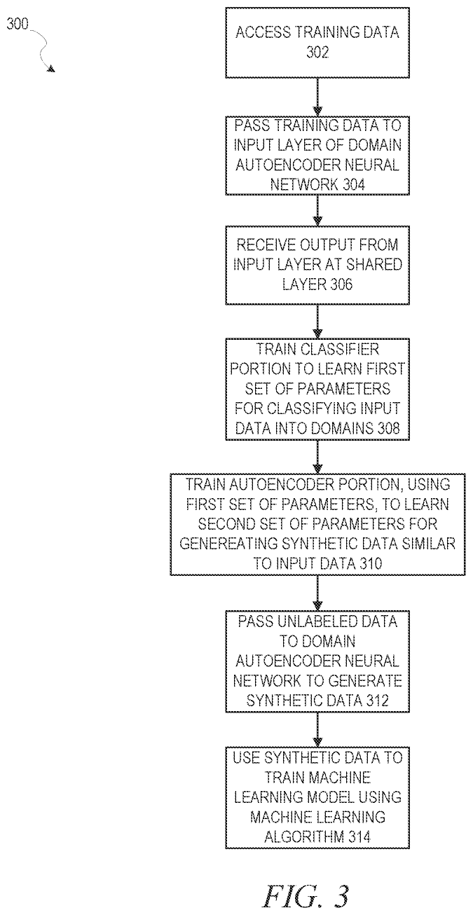

FIG. 3 is a flow diagram illustrating a method 300 of generating synthetic data, in accordance with an example embodiment. At operation 302, training data is accessed. The training data includes data from multiple domains. This means that some of the data is from a first domain and some of the data is from a second domain (additional data from additional domains may also be present as well). At operation 304, the training data is passed to an input layer of a domain autoencoder neural network. At operation 306, output from the input layer is received at a shared layer of the domain autoencoder neural network. The shared layer is a layer that is shared between a classifier portion of the domain autoencoder neural network and an autoencoder portion of the domain autoencoder neural network.

At operation 308, the classifier portion of the domain autoencoder neural network is trained to learn a first set of parameters for classifying input data into domains. More particularly, one or more neurons within one or more layers of the classifier portion of the domain autoencoder neural network may have a parameter that affects a value passed to the respective neuron. These parameters are iteratively modified until some loss function is satisfied, meaning that the parameters have been optimized such that the classifier portion of the domain autoencoder neural network will output classifications of domains of the pieces of training data that best match labels associated with the training data (i.e., the training data may have the respective domains attached as labels). Examples of loss functions include cross-entropy and mean squared error.

At operation 310, the autoencoder portion of the domain autoencoder neural network is trained, using the first set of parameters, to learn a second set of parameters for generating synthetic data based on input data. As with the classifier portion of the domain autoencoder neural network, one or more neurons within one or more layers of the autoencoder portion of the domain autoencoder neural network may have a parameter that affects a value passed to the respective neuron. These parameters are the second set of parameters and are iteratively modified until some loss function is satisfied, meaning that the parameters have been optimized such that the autoencoder portion of the domain autoencoder neural network will output synthetic data that most closely resembles the training data. Further, this training uses the first set of parameters, namely the parameters used to predict domains for data, as part of the learning process for the autoencoder portion (because the autoencoder portion shares the shared layer with the classifier portion), therefore allowing the synthetic data generated when the autoencoder neural network is used with actual unlabeled data to generate synthetic data, to be at least partially be influenced by the predicted domains for the actual unlabeled data.

At operation 312, unlabeled data is passed to the domain autoencoder neural network, thereby outputting generated synthetic data that is similar to the unlabeled data. The domain autoencoder neural network outputs not only synthetic data, but also the predicted origin of the synthetic data. At operation 314, the generated synthetic data is itself used as training data to train a machine learning model using a machine learning algorithm, such as by using linear regression. Notably, the predicted origin of the synthetic data is not used during training.

It should be noted that while the above disclosure describes the use of the generated synthetic data in the context of training data for a separate machine learning algorithm to train a separate machine learning model, there may be many different use cases for the generated synthetic data. Examples include anomaly detection, dimensionality reduction, denoising autoencoding, and data augmentation. Moreover, the domain autoencoder neural network can reduce computation time if many domains are provided and thus save costs because only one neural network needs to be trained. An alternative would be to train one network for each domain, but that would lead to a large number of neural networks that need to be trained separately.

An additional use case is change point detection, which is a process by which a change in time series data values is detected, such as a change from when a company's profit was increasing to when the company's profit was decreasing. Autoencoders may be used for such detection as follows. It is assumed that there are no changepoints in the training dataset of an autoencoder. However, test data contains both timeseries with and without changepoints. Every time a changepoint occurs in test data, the reconstruction loss should be higher than the maximum reconstruction loss during training due to the assumption that no changepoints are in the training dataset. Thus, changepoints are unknown during training and will therefore lead to a higher reconstruction loss during testing. For that reason, it is fundamentally important for this approach to achieve low reconstruction loss during the training phase.

The domain based autoencoder approach could be utilized here to achieve a low reconstruction loss and thus improve the forecast methods.

In view of the above-described implementations of subject matter, this application discloses the following list of examples, wherein one feature of an example in isolation or more than one feature of said example taken in combination and, optionally, in combination with one or more features of one or more further examples are further examples also falling within the disclosure of this application:

Example 1. A system comprising:
at least one hardware processor; and
a computer-readable medium storing instructions that, when executed by the at least one hardware processor, cause the at least one hardware processor to perform operations comprising:
   accessing training data, the training data including data from a first domain and data from a second domain;
   passing the training data to an input layer of a domain autoencoder neural network;
   receiving, at a shared layer of the domain autoencoder neural network, output from the input layer, the shared layer being shared between a classifier portion of the domain autoencoder neural network and an autoencoder portion of the domain autoencoder neural network;
   training the classifier portion to learn a first set of parameters for classifying input data into domains; and
   training, using the first set of parameters, the autoencoder portion to learn a second set of parameters for generating synthetic data based on input data.

Example 2. The system of Example 1, wherein the shared layer is a one-dimensional convolutional layer that takes the output from the input layer and performs one or more convolutions on the output from the input layer to transform the output from the input layer to a different format using one or more filters.

Example 3. The system of Examples 1 or 2, wherein the classifier portion includes a reshaping layer.

Example 4. The system of Example 3, wherein the classifier portion further includes at least one one-dimensional convolutional layer.

Example 5. The system of Example 4, wherein the classifier portion further includes at least one dropout layer.

Example 6. The system of Example 5, wherein the classifier portion further includes a global max pooling layer.

Example 7. The system of Example 6, wherein the classifier portion further includes at least one dense layer.

Example 8. The system of any of Examples 1-7, wherein the operations further comprise:
generating synthetic data similar to data from a first domain by passing the data from the first domain to the trained domain autoencoder neural network; and
using the generated synthetic data as training data using a machine learning algorithm to train a machine-learned model.

Example 9. The system of Example 8, wherein the machine learning algorithm is a linear regression model.

Example 10. A method comprising:
accessing training data, the training data including data from a first domain and data from a second domain;
passing the training data to an input layer of a domain autoencoder neural network;
receiving, at a shared layer of the domain autoencoder neural network, output from the input layer, the shared layer being shared between a classifier portion of the domain autoencoder neural network and an autoencoder portion of the domain autoencoder neural network;
training the classifier portion to learn a first set of parameters for classifying input data into domains; and
training, using the first set of parameters, the autoencoder portion to learn a second set of parameters for generating synthetic data based on input data.

Example 11. The method of Example 10, wherein the shared layer is a one-dimensional convolutional layer that takes the output from the input layer and performs one or more convolutions on the output from the input layer to transform the output from the input layer to a different format using one or more filters.

Example 12. The method of Examples 10 or 11, wherein the classifier portion includes a reshaping layer.

Example 13. The method of Example 12, wherein the classifier portion further includes at least one one-dimensional convolutional layer.

Example 14. The method of Example 13, wherein the classifier portion further includes at least one dropout layer.

Example 15. The method of Example 14, wherein the classifier portion further includes a global max pooling layer.

Example 16. The method of Example 15, wherein the classifier portion further includes at least one dense layer.

Example 17. The method of any of Examples 10-16, further comprising;
generating synthetic data similar to data from a first domain by passing the data from the first domain to the trained domain autoencoder neural network; and
using the generated synthetic data as training data using a machine learning algorithm to train a machine-learned model.

Example 18. The method of Example 17, wherein the machine learning algorithm is a linear regression model.

Example 19. A non-transitory machine-readable medium storing instructions which, when executed by one or more processors, cause the one or more processors to perform operations comprising:
accessing training data, the training data including data from a first domain and data from a second domain;
passing the training data to an input layer of a domain autoencoder neural network;
receiving, at a shared layer of the domain autoencoder neural network, output from the input layer, the shared layer being shared between a classifier portion of the domain autoencoder neural network and an autoencoder portion of the domain autoencoder neural network;
training the classifier portion to learn a first set of parameters for classifying input data into domains; and
training, using the first set of parameters, the autoencoder portion to learn a second set of parameters for generating synthetic data based on input data.

Example 20. The non-transitory machine-readable medium of Example 19, wherein the shared layer is a one-dimensional convolutional layer that takes the output from the input layer and performs one or more convolutions on the output from the input layer to transform the output from the input layer to a different format using one or more filters.

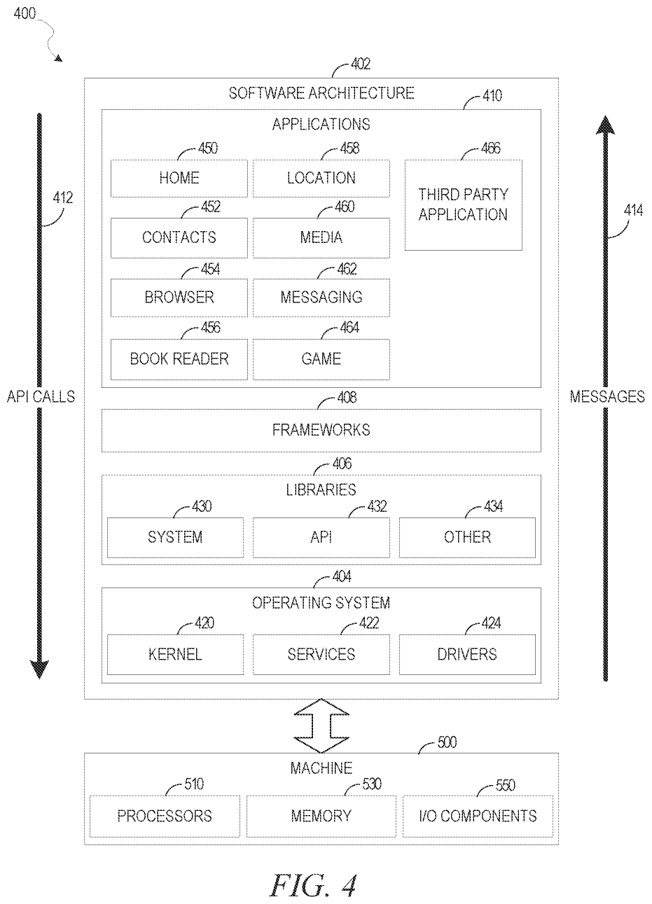

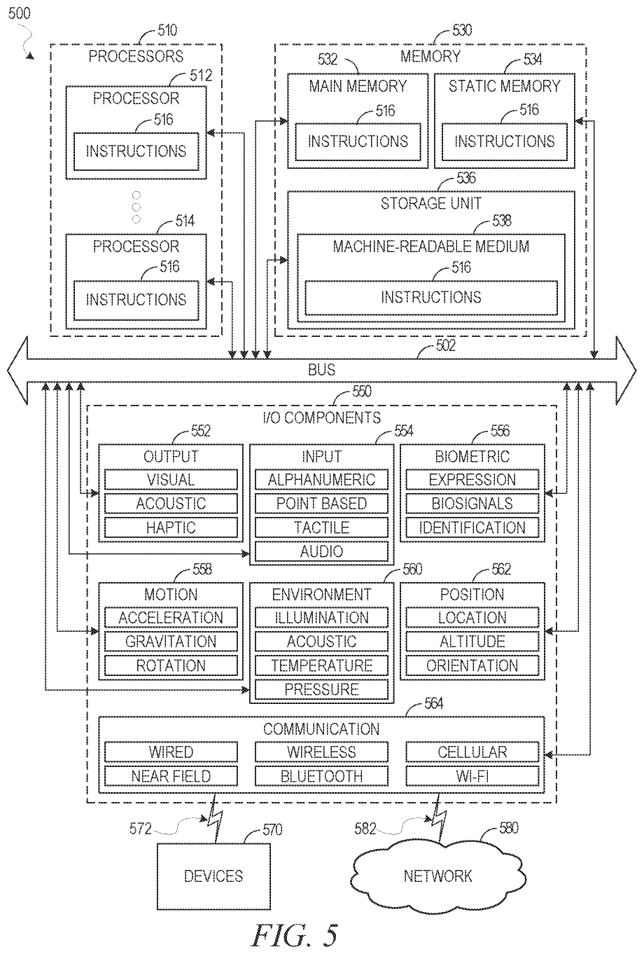

FIG. 4 is a block diagram 400 illustrating a software architecture 402, which can be installed on any one or more of the devices described above. FIG. 4 is merely a non-limiting example of a software architecture, and it will be appreciated that many other architectures can be implemented to facilitate the functionality described herein. In various embodiments, the software architecture 402 is implemented by hardware such as a machine 500 of FIG. 5 that includes processors 510, memory 530, and input/output (I/O) components 550. In this example architecture, the software architecture 402 can be conceptualized as a stack of layers where each layer may provide a particular functionality. For example, the software architecture 402 includes layers such as an operating system 404, libraries 406, frameworks 408, and applications 410. Operationally, the applications 410 invoke Application Program Interface (API) calls 412 through the software stack and receive messages 414 in response to the API calls 412, consistent with some embodiments.

In various implementations, the operating system 404 manages hardware resources and provides common services. The operating system 404 includes, for example, a kernel 420, services 422, and drivers 424. The kernel 420 acts as an abstraction layer between the hardware and the other software layers, consistent with some embodiments. For example, the kernel 420 provides memory management, processor management (e.g., scheduling), component management, networking, and security settings, among other functionality. The services 422 can provide other common services for the other software layers. The drivers 424 are responsible for controlling or interfacing with the underlying hardware. For instance, the drivers 424 can include display drivers, camera drivers, BLUETOOTH® or BLUETOOTH® Low-Energy drivers, flash memory drivers, serial communication drivers (e.g., Universal Serial Bus (USB) drivers), Wi-Fi® drivers, audio drivers, power management drivers, and so forth.

In some embodiments, the libraries 406 provide a low-level common infrastructure utilized by the applications 410. The libraries 406 can include system libraries 430 (e.g., C standard library) that can provide functions such as memory allocation functions, string manipulation functions, mathematic functions, and the like. In addition, the libraries 406 can include API libraries 432 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two-dimensional (2D) and three-dimensional (3D) in a graphic context on a display), database libraries (e.g., SQLite to provide various relational database functions), web libraries (e.g., WebKit to provide web browsing functionality), and the like. The libraries 406 can also include a wide variety of other libraries 434 to provide many other APIs to the applications 410.

The frameworks 408 provide a high-level common infrastructure that can be utilized by the applications 410. For example, the frameworks 408 provide various graphical user interface functions, high-level resource management, high-level location services, and so forth. The frameworks 408 can provide a broad spectrum of other APIs that can be utilized by the applications 410, some of which may be specific to a particular operating system 404 or platform.

In an example embodiment, the applications 410 include a home application 450, a contacts application 452, a browser application 454, a book reader application 456, a location application 458, a media application 460, a messaging application 462, a game application 464, and a broad assortment of other applications, such as a third-party application 466. The applications 410 are programs that execute functions defined in the programs. Various programming languages can be employed to create one or more of the applications 410, structured in a variety of manners, such as object-oriented programming languages (e.g., Objective-C, Java, or C++) or procedural programming languages (e.g., C or assembly language). In a specific example, the third-party application 466 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 466 can invoke the API calls 412 provided by the operating system 404 to facilitate functionality described herein.

FIG. 5 illustrates a diagrammatic representation of a machine 500 in the form of a computer system within which a set of instructions may be executed for causing the machine 500 to perform any one or more of the methodologies discussed herein. Specifically, FIG. 5 shows a diagrammatic representation of the machine 500 in the example form of a computer system, within which instructions 516 (e.g., software, a program, an application, an applet, an app, or other executable code) cause the machine 500 to perform any one or more of the methodologies discussed herein to be executed. For example, the instructions 516 may cause the machine 500 to execute the method of FIG. 3. Additionally, or alternatively, the instructions 516 may implement FIGS. 1-3 and so forth. The instructions 516 transform the general, non-programmed machine 500 into a particular machine 500 programmed to carry out the described and illustrated functions in the manner described. In alternative embodiments, the machine 500 operates as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 516, sequentially or otherwise, that specify actions to be taken by the machine 500. Further, while only a single machine 500 is illustrated, the term “machine” shall also be taken to include a collection of machines 500 that individually or jointly execute the instructions 516 to perform any one or more of the methodologies discussed herein.

The machine 500 may include processors 510, memory 530, and I/O components 550, which may be configured to communicate with each other such as via a bus 502. In an example embodiment, the processors 510 (e.g., a CPU, a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 512 and a processor 514 that may execute the instructions 516. The term “processor” is intended to include multi-core processors that may comprise two or more independent processors (sometimes referred to as “cores”) that may execute instructions 516 contemporaneously. Although FIG. 5 shows multiple processors 510, the machine 500 may include a single processor 512 with a single core, a single processor 512 with multiple cores (e.g., a multi-core processor 512), multiple processors 512, 514 with a single core, multiple processors 512, 514 with multiple cores, or any combination thereof.

The memory 530 may include a main memory 532, a static memory 534, and a storage unit 536, each accessible to the processors 510 such as via the bus 502. The main memory 532, the static memory 534, and the storage unit 536 store the instructions 516 embodying any one or more of the methodologies or functions described herein. The instructions 516 may also reside, completely or partially, within the main memory 532, within the static memory 534, within the storage unit 536, within at least one of the processors 510 (e.g., within the processor's cache memory), or any suitable combination thereof, during execution thereof by the machine 500.

The I/O components 550 may include a wide variety of components to receive input, provide output, produce output, transmit information, exchange information, capture measurements, and so on. The specific I/O components 550 that are included in a particular machine will depend on the type of machine. For example, portable machines such as mobile phones will likely include a touch input device or other such input mechanisms, while a headless server machine will likely not include such a touch input device. It will be appreciated that the I/O components 550 may include many other components that are not shown in FIG. 5. The I/O components 550 are grouped according to functionality merely for simplifying the following discussion, and the grouping is in no way limiting. In various example embodiments, the I/O components 550 may include output components 552 and input components 554. The output components 552 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 554 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 550 may include biometric components 556, motion components 558, environmental components 560, or position components 562, among a wide array of other components. For example, the biometric components 556 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 558 may include acceleration sensor components (e.g., accelerometer), gravitation sensor components, rotation sensor components (e.g., gyroscope), and so forth. The environmental components 560 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 562 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 550 may include communication components 564 operable to couple the machine 500 to a network 580 or devices 570 via a coupling 582 and a coupling 572, respectively. For example, the communication components 564 may include a network interface component or another suitable device to interface with the network 580. In further examples, the communication components 564 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 570 may be another machine or any of a wide variety of peripheral devices (e.g., coupled via a USB).

Moreover, the communication components 564 may detect identifiers or include components operable to detect identifiers. For example, the communication components 564 may include radio-frequency identification (RFID) tag reader components, NFC smart tag detection components, optical reader components (e.g., an optical sensor to detect one-dimensional bar codes such as Universal Product Code (UPC) bar codes, multi-dimensional bar codes such as QR code, Aztec codes, Data Matrix, Dataglyph, Maxi Code, PDF417, Ultra Code, UCC RSS-2D bar code, and other optical codes), or acoustic detection components (e.g., microphones to identify tagged audio signals). In addition, a variety of information may be derived via the communication components 564, such as location via Internet Protocol (IP) geolocation, location via Wi-Fi® signal triangulation, location via detecting an NFC beacon signal that may indicate a particular location, and so forth.

The various memories (i.e., 530, 532, 534, and/or memory of the processor(s) 510) and/or the storage unit 536 may store one or more sets of instructions 516 and data structures (e.g., software) embodying or utilized by any one or more of the methodologies or functions described herein. These instructions (e.g., the instructions 516), when executed by the processor(s) 510, cause various operations to implement the disclosed embodiments.

As used herein, the terms “machine-storage medium,” “device-storage medium,” and “computer-storage medium” mean the same thing and may be used interchangeably. The terms refer to single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media, and/or device-storage media include non-volatile memory, including by way of example semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 580 may be an ad hoc network, an intranet, an extranet, a virtual private network (VPN), a local-area network (LAN), a wireless LAN (WLAN), a wide-area network (WAN), a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 580 or a portion of the network 580 may include a wireless or cellular network, and the coupling 582 may be a Code Division Multiple Access (CDMA) connection, a Global System for Mobile communications (GSM) connection, or another type of cellular or wireless coupling. In this example, the coupling 582 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 8G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions 516 may be transmitted or received over the network 880 using a transmission medium via a network interface device (e.g., a network interface component included in the communication components 564) and utilizing any one of a number of well-known transfer protocols (e.g., Hypertext Transfer Protocol (HTTP)). Similarly, the instructions 516 may be transmitted or received using a transmission medium via the coupling 572 (e.g., a peer-to-peer coupling) to the devices 570. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 516 for execution by the machine 500, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A system comprising:
at least one hardware processor; and
a computer-readable medium storing instructions that, when executed by the at least one hardware processor, cause the at least one hardware processor to perform operations comprising:
accessing training data, the training data including data from a first domain and data from a second domain;
passing the training data to an input layer of a domain autoencoder neural network;
receiving, at a shared layer of the domain autoencoder neural network, output from the input layer, the shared layer being shared between a classifier portion of the domain autoencoder neural network and an autoencoder portion of the domain autoencoder neural network;
training the classifier portion to learn a first set of parameters for classifying input data into domains; and
training, using the first set of parameters, the autoencoder portion to learn a second set of parameters for generating synthetic data based on input data.

2. The system of claim 1, wherein the shared layer is a one-dimensional convolutional layer that takes the output from the input layer and performs one or more convolutions on the output from the input layer to transform the output from the input layer to a different format using one or more filters.

3. The system of claim 1, wherein the classifier portion includes a reshaping layer.

4. The system of claim 3, wherein the classifier portion further includes at least one one-dimensional convolutional layer.

5. The system of claim 4, wherein the classifier portion further includes at least one dropout layer.

6. The system of claim 5, wherein the classifier portion further includes a global max pooling layer.

7. The system of claim 6, wherein the classifier portion further includes at least one dense layer.

8. The system of claim 1, wherein the operations further comprise:
generating synthetic data similar to data from a first domain by passing the data from the first domain to the trained domain autoencoder neural network; and
using the generated synthetic data as training data using a machine learning algorithm to train a machine-learned model.

9. The system of claim 8, wherein the machine learning algorithm is a linear regression model.

10. A method comprising:
accessing training data, the training data including data from a first domain and data from a second domain;
passing the training data to an input layer of a domain autoencoder neural network;
receiving, at a shared layer of the domain autoencoder neural network, output from the input layer, the shared layer being shared between a classifier portion of the domain autoencoder neural network and an autoencoder portion of the domain autoencoder neural network;
training the classifier portion to learn a first set of parameters for classifying input data into domains; and
training, using the first set of parameters, the autoencoder portion to learn a second set of parameters for generating synthetic data based on input data.

11. The method of claim 10, wherein the shared layer is a one-dimensional convolutional layer that takes the output from the input layer and performs one or more convolutions on the output from the input layer to transform the output from the input layer to a different format using one or more filters.

12. The method of claim 10, wherein the classifier portion includes a reshaping layer.

13. The method of claim 12, wherein the classifier portion further includes at least one one-dimensional convolutional layer.

14. The method of claim 13, wherein the classifier portion further includes at least one dropout layer.

15. The method of claim 14, wherein the classifier portion further includes a global max pooling layer.

16. The method of claim 15, wherein the classifier portion further includes at least one dense layer.

17. The method of claim 10, further comprising;
generating synthetic data similar to data from a first domain by passing the data from the first domain to the trained domain autoencoder neural network; and
using the generated synthetic data as training data using a machine learning algorithm to train a machine-learned model.

18. The method of claim 17, wherein the machine learning algorithm is a linear regression model.

19. A non-transitory machine-readable medium storing instructions which, when executed by one or more processors, cause the one or more processors to perform operations comprising:
accessing training data, the training data including data from a first domain and data from a second domain;
passing the training data to an input layer of a domain autoencoder neural network;
receiving, at a shared layer of the domain autoencoder neural network, output from the input layer, the shared layer being shared between a classifier portion of the domain autoencoder neural network and an autoencoder portion of the domain autoencoder neural network;
training the classifier portion to learn a first set of parameters for classifying input data into domains; and
training, using the first set of parameters, the autoencoder portion to learn a second set of parameters for generating synthetic data based on input data.

20. The non-transitory machine-readable medium of claim 19, wherein the shared layer is a one-dimensional convolutional layer that takes the output from the input layer and performs one or more convolutions on the output from the input layer to transform the output from the input layer to a different format using one or more filters.
